(19) United States
(12) Patent Application Publication
(10) Pub. No.: US 2005/0179010 A1
(43) Pub. Date: Aug. 18, 2005

(54) Surface base-coat formulation for metal alloys

(76) Inventor: Chhiu-Tsu Lin, Sycamore, IL (US)

Correspondence Address: Kenneth I Kohn;Kohn & Associates, Suite 410, 30500 Northwestern Highway, Farmington Hills, MI, 48334, US

(21) Appl. No.: 10/505,241

(22) PCT Filed: Mar. 5, 2003
(86) PCT No.: PCT/US03/06609

Related U.S. Application Data
(60) Provisional application No. 60/362,058, filed on Mar. 5, 2002.
(60) Provisional application No. 60/373,151, filed on Apr. 17, 2002.

(51) Int. Cl. C09K 3/00; C08K 5/24

(52) U.S. Cl. 252/387; 524/261

(57) ABSTRACT

Chromium-free coating composition with anti-corrosion and anti-fingerprint properties, particularly suitable for metal alloys, especially galvanized steel, and coated articles. Composition comprises aqueous-resin emulsion, hazardous air pollutant-free co-solvent, organo-functional silane, metal chelating agent, and chromium-free corrosion inhibitor, and optionally pH adjusting agent.

### BACKGROUND OF THE INVENTION

1. Technical Field

The present invention relates to a coating for metal alloys. More specifically, the present invention relates to a chrome-free coating for protecting metal alloys from deterioration and corrosion.

2. Background Art

It is well known in the art that galvanized steel must be protected from oxidation. Various methods have been developed for protecting against oxidation. Some examples include chromate treatment technology and electrolytic chromate treatment technology. However, one problem with these methods is that the methods are unable to form a chromate film on metals simply by coating the metals and then drying.

Unlike reactive chromate treatment technology and electrolytic chromate treatment technology, dry-in-place chromate treatment technology is able to form a chromate film on metals simply by coating the metals and then drying. As a result, a distinguishing feature of dry-in-place chromate treatment is that it is not limited to particular metal substrates. As a result, dry-in-place chromate treatment is frequently used to impart corrosion resistance to metal surfaces to improve their adherence to resins and most importantly to improve paint adherence and post-painting corrosion resistance when painting is carried out.

At the present time, the main metals used in flat sheet structures are zinciferous-plated steel sheet, aluminum, and aluminum alloy flat sheet. These are widely used in such economic sectors as automotive applications, household electrical appliances, building materials, and so forth. These materials are almost inevitably subjected to a chromate treatment due to contemporary demands for high added value.

A distinguishing feature of dry-in-place chromate treatment technology is that it is not limited to particular metal substrates. However, this technology has other advantages. Because a desirable film is obtained through just a simple application step, there is no specific requirement for long reaction times, and simple equipment can be used, so that the line length can be reduced. Moreover, the effluent treatment load is light because a post-treatment water rinse is not required. Also, because dry-in-place films usually contain a higher proportion of corrosion-inhibiting hexavalent chromium than do reactive chromate and electrolytic chromate films, dry-in-place chromate films can provide a higher corrosion resistance than the other two types at the same add-on weight.

The corrosion-inhibiting hexavalent chromium is soluble in the water of wet corrosive ambients. One drawback to dry-in-place chromate films is that they are generally more soluble in water than reactive or electrolytic chromate films. The main component exhibiting water solubility in dry-in-place chromate films is the hexavalent chromium ions, and films exhibiting a high water solubility of this type are denoted below as “low-fixed-chromium” films. As is well known, the hexavalent chromium ions are pollutants, and this fact has generally created demand for a sparingly water-soluble dry-in-place chromate film having a high proportion of fixed or immobilized chromium.

In addition to the problem of environmental pollution, the low proportion of fixed chromium in dry-in-place chromate films creates other problems for industrial application. One such problem is that the alkaline degreasing process elutes hexavalent chromium. A degreasing step is generally required during the conversion of dry-in-place chromated metal stock into finished product. The degreasing step takes place in downstream channels in order to remove contaminants, such as oil, dust, iron powder, and the like, that have been picked up during various stages and of course during press forming. Since traditional solvent degreasing is in the course of being discontinued due to global environmental issues, waterborne degreasing, such as alkaline degreasing, normally must be employed for this purpose. The elution of a portion of the dry-in-place chromate film by alkaline degreasing requires the installation of special effluent treatment facilities in order to treat the hexavalent chromium ions in the spent degreasing bath.

Another problem occurs when waterborne resin coatings are applied on dry-in-place chromated stock. A very recent trend with flat sheet metal stock is that the stock is increasingly being painted with organic resin at the manufacturing stage in order to obtain various characteristics such as corrosion resistance, fingerprint resistance, lubricity, and insulating characteristics. Again, in the case of organic resins, solvent-based resins are being replaced by waterborne resins for the same environmental reason as above. The hexavalent chromium ions eluted from dry-in-place chromate coatings inhibit dispersion of the waterborne resin in such waterborne resin coatings. This either prevents normal application and formation of the resin coating or ends up gelling the resin coating bath itself.

The reasons outlined above have prompted strong demand for the appearance of a dry-in-place chromate treatment bath that provides a sparingly water soluble film, i.e., a “high-fixed-chromium” film.

Dry-in-place chromate treatment baths generally take the form of Cr³⁺-containing aqueous chromic acid or dichromic acid solutions, and several methods have already been proposed that provide sparingly water-soluble dry-in-place chromate films using such baths.

Japanese Examined Patent Application [Kokoku] Number Sho 61-58552 [58,552/1986] discloses a method that uses a chromating bath based on chromic acid, chromic acid reduction product, and silica sol. However, the hexavalent chromium in the chromate film is still readily eluted when a surface-treated steel sheet bearing a chromate film formed by this method is submitted, during processing and painting operations, to a pre-paint alkaline rinse. This causes the corrosion resistance of the film to decline.

Japanese Patent Application Laid Open [Kokai or Unexamined] Numbers Sho 58-22383 [22,383/1983] and Sho 62-83478 [83,478/1987] teach the use of a silane coupling agent to reduce hexavalent chromium ions in the chromate treatment bath. In each case the coatings afforded by these methods have an excellent paint film adherence. However, the chromate film afforded by the former method has a poor alkali resistance, because it is laid down from a phosphoric acid-free chromate treatment bath. The chromate film afforded by the latter method also has a similarly inadequate alkali resistance.

Japanese Patent Application Laid Open [Kokai or Unexamined] Number Sho 63-96275 [96,275/1988] teaches a treatment method that uses a chromate treatment bath containing organic resin whose molecule has been functionalized with specific amounts of hydroxyl group. The alkali resistance is again often inadequate in this case because the organic resin in the chromate coating formed by this method contains carboxyl moieties produced by oxidation by chromic acid. In addition, the treatment bath stability in this case is strongly impaired because the reaction of the hydroxyl-functional organic resin and chromic acid proceeds even in the treatment bath itself.

Japanese Patent Publication [Kokoku] Number Hei 7-33583 [33,583/1995] teaches a chromate treatment method that uses a chromate treatment bath containing carboxylic acid and/or a carboxylic acid derivative. This chromate treatment bath affords only an inadequate improvement in application performance. In addition, because baking at 150° C. to 300° C. is required, this method entails substantial cost for its heating facilities, which runs counter to the current trend of economizing on energy. Thus, drying temperatures not exceeding 100° C. are desirable in order to fully exploit the overall merits of dry-in-place chromate treatment systems.

As has been described above, the prior dry-in-place chromate treatment baths and treatment methods have suffered from a number of drawbacks, and a dry-in-place chromate treatment bath and treatment method that would be free of these drawbacks has remained heretofore unknown. In other words, to date there has yet to appear a dry-in-place chromate treatment bath and corresponding treatment method that provide a good application performance and bath stability while also providing metal surfaces with a sparingly water soluble chromate film with a good alkali resistance, water resistance, corrosion resistance, and paint film adherence.

Rust-proof properties have conventionally been imparted to cold-rolled steel sheets, galvanized steel sheets, zinc-based alloy-plated steel sheets, and aluminum-plated steel sheets used for automobiles, electrical appliances, building materials, and the like, usually by coating their surfaces with chromate layers. Chromating treatment includes electrolytic chromating and application chromating. Electrolytic chromating is accomplished, for example, by using a bath composed mainly of chromic acid and also containing other anions such as sulfate, phosphate, borate, and halogens, for treatment of the metal sheet by cathodic electrolytic treatment. Application chromating is designed in consideration of the problem of elution of chromium from chromated metal sheets, and it thus involves preparation of a treatment solution by adding an inorganic colloid or inorganic anion to a solution with a portion of the hexavalent chromium portion reduced to trivalent chromium beforehand or to a solution with a specified ratio of hexavalent chromium to trivalent chromium, and immersing the metal sheet therein or spraying the metal sheet with the treatment solution.

Those chromate layers formed by electrolysis do not have sufficient corrosion resistance despite the low elution of hexavalent chromium and there is particular loss of corrosion resistance in cases where considerable layer damage occurs during working, etc. On the other hand, while metal sheets coated with application chromated layers have high corrosion resistance and especially high excellent corrosion resistance of worked sections, elution of hexavalent chromium from the chromate layers has been a problem. Elution of hexavalent chromium can be considerably reduced by coating with organic polymers, but this is still inadequate. Although an improvement in reducing elution of hexavalent chromium can generally be achieved by a method known as resin chromating treatment, such as disclosed in Japanese Unexamined Patent Publication No. 5-230666, it is still impossible to avoid trace elution.

Thus, in order to completely inhibit elution of hexavalent chromium, it is necessary to develop a corrosion-resistant layer that uses absolutely no hexavalent chromium.

One previous anti-corrosion technique for incorporating absolutely no hexavalent chromium is a method under development that uses an organic-based corrosion inhibitor. The presently known organic-based corrosion inhibitors include carboxylates such as benzoates, azelates, etc. and compounds containing —S—, —N—(which readily interact with metal ions), as well as complexes thereof.

Techniques for including organic-based corrosion inhibitors in layers have been proposed. Examples of such layers include the hydrooxime complex of zinc disclosed in Japanese Unexamined Patent Publication No. 62-23989, the metal chelate compounds of Mg, Ca, Ba, Zn, Al, Ti, Zr, Sn, Ni, etc. disclosed in Japanese Unexamined Patent Publication No. 3-183790 and Japanese Unexamined Patent Publication No. 2-222556, the alkali earth metal salts, transition metal salts, and transition metal complexes of organic compounds disclosed in Japanese Unexamined Patent Publication No. 6-321851 and the titanium and zirconium complexes of carboxylic acids disclosed in Japanese Unexamined Patent Publication No. 8-48916. These corrosion inhibitors, however, have weak anti-corrosion effects due to the metal elements forming the complexes and thus have failed to provide the same function as hexavalent chromium. In particular, almost no corrosion resistance can be expected at damaged sections or at the locations of layer defects produced during working.

Japanese Unexamined Patent Publication No. 7-188951 discloses a rare earth metal-organic chelate compound for the purpose of inhibiting corrosion of metals that contact solutions, such as radiators or pipes. This corrosion inhibitor was designed as a water-soluble compound, to allow continuous provision of the corrosion inhibitor to corrosion sites by circulation of the solution. Consequently, although the strong anti-corrosion effect of the rare earth metal element is utilized, with layers on metal sheets wherein the absolute amount of corrosion inhibitor onto the corrosion sites is limited by the coating coverage, elution occurs out of the layer in humid atmospheres so that long-term corrosion resistance comparable to chromate layers cannot be achieved.

An example of an anti-corrosive layer is a magnesium alloy materials. Magnesium alloy materials have the lightest weight among the practical metallic materials. Magnesium alloy materials also have a large specific strength and a good castabilty. Wider application of the materials to cases, structural bodies, various parts, etc. of household appliances, audio systems, aircrafts, automobiles, etc. has been desired. Particularly, Al-containing AZ91D (Al: 8.3-9.7 wt. %) and AM60B (Al: 5.5-6.5 wt. %) have a good fluidity in die-casting and thixo molding and thus are most desirable alloys.

However, magnesium has the most basic normal electrode potential among the practical metallic materials resulting in high corrosion susceptibility when the metal is brought into contact with other metals and a considerably poor anti-corrosiveness in an aqueous acidic, neutral, or chloride solution. For its application to corrosion-excluding positions, e.g. good appearance-maintaining positions etc., it is necessary to provide an anticorrosive treatment. The thin coat and conductive layer are preferred. Coatings are the most popular anti-corrosion means, but it is hard to apply coatings to magnesium alloy materials per se because of the disadvantage that the resulting coating film has poor adhesiveness. Sometimes, corrosion may occur under the coating film, and thus it is the ordinary practice to conduct a substrate surface treatment in advance of the coating process.

The substrate surface treatment technology includes, for example, substrate surface treatments of forming a metal oxide film or a sparingly soluble salt film by chemical conversion treatment or anodizing using such heavy metal oxo acid salts as chromates, permanganates, or phosphates so as to improve the corrosion resistance and the adhesiveness of coating films. The chemical conversion coatings generate a large amount of wastewater and toxic chemical contaminants.

It is also the ordinary coating practice to use oil paints and synthetic resin paints that contain lead compounds, zinc powder and its compounds, chromates, etc. as an anticorrosive pigment.

Processes for forming an anticorrosive film on a magnesium alloy are disclosed in JP-A-9-176894 and JP-A-9-228062.

Surface treatments using specific chemical compounds such as chromates and permanganates have problems relating to environmental friendliness, such as effluent water pollution problems and skin allergy problems for operators. The use of such surface treatments is increasingly subject to strict regulations. Phosphates are also more or less harmful to the environment and the corrosion resistance of resulting phosphate films is not satisfactory. The salt (fog) spray test (ASTM B117) shows corrosion in 24 hours. Substitute processes for such substrate surface treatments are under development but these methods still have problems with respect to corrosion resistance.

Lead compounds or chromates contained as anticorrosive pigments in coating technology have problems relating to environmental friendliness. Furthermore, there are occasionally problems relating to corrosions. These problems are due to diffusion of oxygen or water generated by corrosion present under the coating film or by coating film defects.

The invention disclosed in Japanese patent JP-A-9-176894 relates to an electrolytic treatment. Anodizing requires a power source of high voltage. An entirely uniform film is hard to obtain. The patent discloses treatments using an organometal that are highly reactive and thus an entirely uniform film is likewise hard to obtain.

It would be useful to develop an alloy coating that is easy to apply, environmentally friendly, and anti-corrosive. The preferred coating is a water-based system containing no carcinogenic chromates and no hazardous air pollutant (HAP) co-solvents.

### SUMMARY OF THE INVENTION

According to the present invention, there is provided a metal alloy coating composition, the coating having a chrome-free environmentally friendly formulation. The coating can be used as an anti-corrosion coating and an anti-fingerprint coating.

### BRIEF DESCRIPTION OF THE DRAWINGS

FIGS. 1A and B are photographs showing two panels coated with this chrome- and HAP-free formulation were subjected to 120 hours of ASTM B-117 testing;

FIGS. 2A and B are photographs that display panels of 2024-T3 Bare/Alodine 1200 (FIG. 2A) and on 2024-T3 Bare/AFP (FIG. 2B) coated with AD9318/AD2298 primer after a 1000 hour salt spray test; and

FIG. 3 shows the Bode-magnitude plots (frequency vs. impedance) of AD9318/AD2298 coated on 2024-T3 Bare/AFP panels after soaking in 3% NaCl solution for 72 hours (♦) and 1000 hours (▴), and those on 2024-T3 Bare/Alodine 1200 panels soaked for 72 hours (●) and 1000 hours (▪).

### DESCRIPTION OF THE INVENTION

Generally, the present invention provides a metal alloy coating. The coating is an emulsion that contains only environmentally friendly materials. The coating is able to meet all quality control standards with regard to electrical resistance, corrosion resistance, abrasion resistance, and adhesion to metal surface and topcoat (liquid and powder paints).

The present invention provides a chrome-free, water-based, and hazardous air pollutant (HAPs)-free formulation for a pretreatment coating. The coating can be applied before any primers and topcoats are applied to a surface. These surface pretreatment coatings have excellent protective performance (alkaline and salt spray resistances) for galvanized steel (electrogalvanized and hot-dip, and galvalume), magnesium alloys (such as AZ31, AM20), titanium alloys (such as Ti-6Al-4V), and aluminum alloys (such as 2024-T3, 7075-T6), and other similar alloys for surface pretreatment and corrosion protections. The galvanized steel, and magnesium, titanium, and aluminum alloys are currently used in computer, cellular phone, notebook, bicycles, and aerospace industries. These surface coatings also offer a superior property for adding primers and/or topcoats.

More specifically, the coating of the present invention includes the following: 60-70% by weight of water, 15-25% by weight of resins, 10-20% by weight hazardous air pollutants (HAPs)-free co-solvents (such as dipropylene glycol normal butyl ether—DPnB, propylene glycol normal butyl ether—PnB), 0.4-5% by weight organofunctional silanes (such as functionalized mercaptosilianes, functionalized aminosilanes, functionalized vinylsilanes), 0.1-1.0% by weight corrosion inhibitors, 0.1-1.0% by weight metal chelating agents, and a trace amount of pH adjusting agents. A specific example of a surface base-coat formulation is as follows: the chrome-free, HAPs-free, and water-based emulsion contains 94 g water, 32 g acrylic co-polymer resin, 25 g HAPs-free co-solvents, 0.54 g chrome-free corrosion inhibitors, 0.2 g metal chelating agents, 0.27 g pH adjusting agents, and 3 g functionalized silanes.

The term “resin” includes, but is not limited to, acrylic emulsion, polyurethane emulsion, co-polymer emulsion, and other similar compounds. This list is included to exemplify the resins that can be used. The list is not intended to be exhaustive. Those of skill in the art know additional resins that are of a sub-micrometer or nanometer particle size that can be utilized in the present invention.

The phrase “organofunctional silanes” as used herein is intended to include, but is not limited to, silanes that are sterically hindered substituents located at silicon atoms. Preferably, the functional groups are vinyl, epoxy, sulfur, amino, and other similar groups. This list is included to exemplify the organofunctional silanes that can be used. The list is not intended to be exhaustive. Those of skill in the art know additional organofunctional silanes that can be utilized in the present invention.

By “corrosion inhibitor” as used herein, the phrase is intended to include, but is not limited to, silicates, vanadates, metaborates, manganates, phosphates, mercapto-compounds, xanthic acid salts, dithiocarbamic acid salts, organic carboxylates, and other similar compounds. This list is included to exemplify the corrosion inhibitors that can be used. The list is not intended to be exhaustive. Those of skill in the art know additional corrosion inhibitors that can be utilized in the present invention.

The phrase “pH adjusting agent” as used herein is intended to include, but is not limited to, the following agents: ammonia, organic amines, and other similar agents. This list is included to exemplify the pH-adjusting agents that can be used, the list is not intended to be exhaustive. Those of skill in the art know additional pH adjusting agents that can be utilized in the present invention.

The term “protection” as used herein means that the coating composition forms a layer inhibiting oxidation of the underlying surface and resisting the alkaline solution washing (or degreasing). The coating of the present invention is able to protect the underlying surface from corrosion. For example, when the coating of the present invention was applied to a surface, no corrosion is detected after 96 hours in salt (fog) spray test (ASTM B117). The coating shows no removal of paint film after subjecting to 2-3% trisodium phosphate solution at 65° C. for 3-5 minutes.

The coating formulation of the present invention is preferably applied to the surface of a metal alloy substrate using techniques known to those of skill in the art. The preferred magnesium alloy substrate for use in the present invention has excellent forgeability to form a thin casing with sharp bottom edges, corners and projections whose inner surfaces preferably have radii of curvature of about 2 mm or less, particularly about 1 mm or less. Preferably, the magnesium alloy used in the present invention has a composition of 1-6 weight percent of Al, 0-2 weight percent of Zn and 0.5 weight percent or less of Mn, the balance being substantially Mg and inevitable impurities.

When the amount of aluminum is less than one weight percent, the magnesium alloy has poor toughness, though it is well forgeable. On the other hand, when the amount of aluminum is more than six weight percent, the magnesium alloy has poor forgeability and corrosion resistance. The preferred amount of aluminum is two to four weight percent, particularly about three weight percent.

Zinc has similar effects as those of aluminum. From the aspect of forgeability and metal flow, Zn is preferably zero to two weight percent. The preferred amount of Zn is zero to one weight percent.

If added in a small amount, magnesium functions to improve the microstructure of the magnesium alloys. From the aspect of mechanical properties, magnesium is preferably 0.5 weights percent or less.

The magnesium alloy can contain other elements such as rare earth elements, lithium, zirconium, etc., in such amounts as not to adversely affect the forgeability, mechanical strength, etc. of the magnesium alloys, usually in a total amount as small as 0.2 weight percent or less.

The magnesium alloys satisfying the above composition requirements are commercially available as AZ31 (Al: about 3 weight percent, Zn: about 1 weight percent, Mn: 0.2-0.3 weight percent, Mg and inevitable impurities: balance), AM20 (Al: about 2 weight percent, Mn: about 0.5 weight percent, Mg and inevitable impurities: balance), etc., in ASTM.

The magnesium alloy body is preferably formed into a thin forged casing by at least two steps. In a preferred embodiment, the forging comprises a first forging step and a second forging step. If necessary, a further forging step can be added between the first and second forging steps.

The first forging step involves shaping the body. The magnesium alloy body can be in any shape such as rectangular parallelepiped, cylinder, etc., as long as it is forgeable to a desired shape. However, it has been found that when the magnesium alloy body is in a thick bulk shape, the resultant forged product has flow marks on the surface. The term “flow marks” means marks indicating traces of plastic flow of the magnesium alloy occurring during the forging process.

When a thin magnesium alloy body is forged at a low compression ratio, the flow marks can be suppressed, because disturbed plastic flow does not occur at a low compression ratio. The term “compression ratio” used herein means a ratio (percentage) expressed by the formula: [(t₀-t_{f})/t₀]×100%, wherein t₀ is an original thickness of the magnesium alloy body to be forged, and t_{f} is a thickness of the forged product.

A compression ratio is preferably within 75% in the first forging step and within 30% in the second forging step to sufficiently suppress the flow marks on the resultant thin forged casings. To achieve the above compression ratios, the magnesium alloy body is preferably in a thin plate shape having a thickness of about 3 mm or less. With such a thin magnesium alloy plate, the mechanism of plastic flow can be utilized to produce a thin forged casing with no flow marks. Because the original surface conditions of the magnesium alloy plates are substantially kept on the forged products, it is preferable to use the magnesium alloy plates with extremely small surface roughness. In the case of a round magnesium alloy rod, the compression ratio can usually be more than 80%.

In the case of forming a forged casing of about 1.5 mm or less in thickness, with an anodic oxidation coating for exhibiting metallic glow, it is important to forge a thin magnesium alloy plate of about 3 mm or less, preferably about 2 mm or less, particularly about 1-1.5 mm in thickness.

Though the size of the magnesium alloy plate can be determined depending on the compression ratio, it is preferable that the magnesium alloy plate is equal to or slightly larger than a bottom area of the final thin forged casing. When the magnesium alloy plate is too large, the resultant thin forged casings are likely to have wrinkles at bottom edges and corners, lowering the yield of the final products. On the other hand, when the magnesium alloy plate is too small, the resultant thin forged casings are unlikely to be uniform in thickness in peripheries.

The magnesium alloy body to be forged is first preheated uniformly at a temperature of 350-500° C., slightly higher than the forging temperature of the magnesium alloy body. The preheating temperature of the magnesium alloy body is defined herein as a temperature of atmosphere inside an electric furnace in which the magnesium alloy body is heated.

If the preheating temperature is lower than 350° C., the magnesium alloy does not smoothly flow into the die cavity during the forging process, thus failing to make the thickness of the resultant forged casing as small as about 1.5 mm or less. If the preheating temperature is higher than 500° C., the magnesium alloy body is totally or partly melted, resulting in extreme metal flow marks appearing on the surface, which makes it impossible to obtain a thin forged casing with high quality. Also, a higher temperature causes excessive oxidation and even burning of the magnesium alloy during the forging process. The preferred preheating temperature of the magnesium alloy body is 350-450° C., particularly 400-450° C.

If the magnesium alloy body is heated in the air, a surface of the magnesium alloy body is severely oxidized, adversely affecting the forgeability, corrosion resistance, and surface appearance of the resultant thin forged casing. The preheating of the magnesium alloy body is carried out in vacuum or in an inert gas atmosphere such as an argon gas, etc.

The preheating time is determined depending on the size of the magnesium alloy body. For instance, it is about 10-20 minutes for a cylindrical magnesium alloy body of 30 mm in diameter and 10-30 mm in length. If the magnesium alloy body were in a thin plate shape of about 3 mm or less in thickness, the preheating time would be sufficient to be as short as 5-15 minutes.

The first forging step can be carried out on the magnesium alloy body under conditions of a die temperature of 350-450° C., a compression pressure of 3-30 tons/cm², a compressing speed of 10-500 mm/sec, and a compression ratio of 75% or less.

The die temperature is almost equal to the first forging temperature. When the die temperature is lower than 350° C., the preheated magnesium alloy body is so cooled by contact with the die that sufficient metal flow cannot be achieved during the first forging step, resulting in rough forged surface. On the other hand, when the die temperature is higher than 450° C., the forged product cannot easily be removed from the die. The preferred die temperature is 360-420° C. The first forging temperature is about 50-80° C. lower than a temperature at which the magnesium alloy starts melting to prevent the magnesium alloy from melting locally during the first forging step.

The pressure at which the magnesium alloy body is compressed by a pair of die blocks is 3 tons/cm² or more. When the compression pressure is less than 3 tons/cm², the resultant intermediate forged product cannot be made fully thin. The upper limit of the compression pressure can usually be determined based upon the compression ratio. Too high compression pressure causes damage to the edges of the die. In addition, even though the compression pressure exceeds 30 tons/cm², further improvements in the quality of the forged products cannot be obtained. The upper limit of the compression pressure is 30 tons/cm². The preferred compression pressure in the first forging step is 5-25 tons/cm².

The compressing speed of the magnesium alloy body can be 10-500 mm/sec. When the compressing speed is less than 10 mm/sec, the productivity of the intermediate forged products is too low. When the compressing speed is more than 500 mm/sec, metal flow cannot follow the compression of the magnesium alloy body, resulting in disturbed metal flow, which leads to extreme flow marks on the surface of the body. The preferred compression speed in the first forging step is 50-300 mm/sec.

The compression ratio is preferably within 75% in the first forging step to sufficiently suppress the flow marks on the resultant intermediate forged products. If the compression ratio exceeds 75%, it is difficult to prevent the flow marks from appearing on the surfaces of the resultant intermediate forged products. The more preferred compression ratio in the first forging step is 50-50%, particularly 18-45%.

The forging can be carried out mechanically or hydraulically.

The second forging step includes preheating the intermediate forged product. The intermediate forged product obtained in the first forging step is preheated uniformly at a temperature of 300-500° C. in vacuum or in an inert gas atmosphere such as an argon gas, etc. If the preheating temperature of the intermediate forged product is lower than 300° C., smooth metal flow does not occur along the cavity surface of the forging die during the second forging step, thereby failing to precisely transfer the cavity surface contour of the second forging die to the final thin forged casing. If the preheating temperature is higher than 500° C., the intermediate forged product can be melted in portions subjected to strong friction, resulting in extreme flow marks appearing on the surface. The preferred preheating temperature of the intermediate forged product is 350-450° C.

The preheating time of the intermediate forged product is also determined based upon the size of the intermediate forged product. For instance, it is about 5-15 minutes for the intermediate forged product of 1 mm in thickness.

The second forging step is preferably carried out on the intermediate forged product under the conditions of a die temperature of 300-400° C., a compression pressure of 1-20 tons/cm², a compressing speed of 1-200 mm/sec., and a compression ratio of 30% or less.

The die temperature is almost equal to the second forging temperature but can be slightly lower than the first forging temperature because the compression ratio is smaller in the second forging step than in the first forging step. When the die temperature is lower than 300° C., the preheated intermediate forged product is so cooled by contact with the die that cavity surface contour cannot be precisely transferred from the second forging die to the resultant thin forged casing by the second forging step. When the die temperature is higher than 400° C., the forged product cannot easily be removed from the die. Therefore, the preferred second die temperature is 330-400° C.

The compression pressure in the second forging step can be smaller than in the first forging step, and is preferably 1-20 tons/cm². When the compression pressure is less than 1 tons/cm², the resultant forged casing cannot be made fully thin with excellent surface contour. When the compression pressure exceeds 20 tons/cm², further improvements in the quality of the forged products cannot be obtained. The preferred compression pressure in the second forging step is 5-15 tons/cm².

The compressing speed of the intermediate forged product can be 1-200 mm/sec. When the compressing speed is less than 1 mm/sec, the productivity of the forged casings is too low. When the compressing speed is more than 200 mm/sec, the cavity surface contour of the second forging die cannot be precisely transferred to the thin forged casing, failing to provide the thin forged casing with excellent surface conditions. The preferred compression speed in the second forging step is 20-100 mm/sec.

The compression ratio is preferably within 30% in the second forging step to sufficiently suppress the flow marks on the resultant thin forged casings. If the compression ratio exceeds 30%, it is difficult to prevent the flow marks. from appearing on the surfaces of the resultant thin forged casings. The more preferred compression ratio in the second forging step is 5-20%.

In one embodiment, the thin forged casing of the present invention can be a box-shaped, thin plate that has projections of various heights on either or both surfaces. The thickness of the thin plate in areas without projections is preferably as small as about 1.5 mm or less, more preferably about 1 mm or less. The projections can be bosses for screw holes, projections indicating alphabets, numbers and/or symbols, etc. Of course, the thin plate portion can have thinner regions than the remainder unless the thinner regions affect the mechanical strength of the thin forged casing.

The thin forged casing of the present invention preferably has sharp bottom edges, corners and projections. Particularly in the case of small casings, for instance, those of minidisks, the inner surfaces of bottom edges and corners preferably have radii of curvature of 1 mm or less. Sharp bottom edges, corners, and projections whose inner surfaces have such small radii of curvature can be provided only by the forging method of the present invention.

The resultant thin forged casing is trimmed at sidewalls by a cutter, etc. such that the sidewalls have exactly the same height. If necessary, screw bores can be formed in the boss projections. The thin forged casing can then be polished.

After polishing, the thin forged casing is subjected to a surface coating such as an anodic oxidation coating, a paint coating, etc. and the anti-corrosion coating of the present invention. In the present invention, a chrome-free and HAPs-free aqueous emulsion is preferred. The coating can be applied in any manner known to those of skill in the art. Examples of such techniques include, but are not limited to, spraying the coating on the surface to be coated, dipping the surface in the coating composition, and painting the coating on the surface to be coated.

The anodic oxidation coating can be applied using methods known to those of skill in the art. An electrolytic solution for anodic oxidation can have a composition comprising one or more of sodium dichromate, acidic sodium fluoride, acidic potassium fluoride, acidic ammonium fluoride, ammonium nitrate, sodium dihydrogenphosphate, ammonia water, etc. The electrolytic components can be combined depending on the composition of the magnesium alloy, the desired color of the thin forged casing, etc.

Because the anodic oxidation coating is generally transparent with or without tint, the anodized thin forged casing keeps metallic gloss inherent in the magnesium alloy.

Though the paint coating can be applied with any paint, it is preferable to coat a clear paint if metallic gloss is desired. The clear paint can be made of thermosetting acrylic resins, polyester resins, epoxy resins, etc. without or trace of pigments like clear coatings of automobiles, etc. Before coating, the thin forged casing is preferably subjected to a surface base-coat of aqueous emulsion with the anti-corrosive treatment of the present invention. The anti-corrosive coating is applied as a single coat on the surface of the magnesium alloy. The coated alloy is thermally cured at approximately 125° C. for three to five minutes. The dry film of final coating is approximately 1.6 μm thick with a resistance of approximately 0.3Ω. The coating provides an excellent metal surface (and top coat) adhesion and can pass a salt spray test of >72 hours that is superior to those chemical conversion coatings known in the prior art.

The invention is further described in detail by reference to the following experimental examples. These examples are provided for the purpose of illustration only, and are not intended to be limiting unless otherwise specified. Thus, the invention should in no way be construed as being limited to the following examples, but rather, should be construed to encompass any and all variations which become evident as a result of the teachings provided herein.

### EXAMPLES

### Example 1

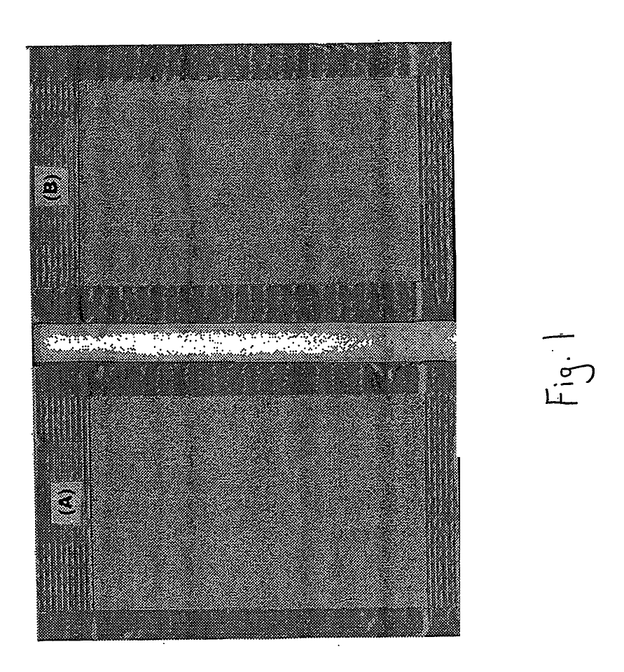

A chemically pretreated galvanized or zinc-alloy-plated steel sheet is commonly used to inhibiting corrosions of steel substrates. The processed galvanized steel has poor fingerprint resistance and earthing properties. The corrosion inhibition galvanized steel is also poor, leading to the formation of white rust covered the entire zinc coated steel in less than 24 hours in a salt (fog) spray test (ASTM B-117). The galvanized steel is utilized in large quantity for electronic parts, equipment or the like that require good fingerprint resistance, earthing properties, and corrosion resistance. In current industrial practice, the ultra thin organic coatings (about 1 micrometer thick) are generally applied on high-speed lines. This desired organic coating should have excellent anti-fingerprinting characteristics, resist to alkaline solution (i.e. 2% tri-sodium phosphate solution at 65 degrees C. for 2 minutes) and passes a 120 hours salt (fog) spray test (ASTM B117). These chrome- and HAP-free anti-fingerprint coatings have been tested at different independent laboratories, and have been shown to pass both alkaline solution washing and 120 hours salt (fog) spray tests. Two panels coated with this chrome- and HAP-free formulation were subjected to 120 hours of ASTM B-117 testing at the China Steel Corporation and are shown in FIGS. 1A and B. FIG. 1A was tested without alkaline solution washing, and FIG. 1B was tested after 2 minutes of alkaline washing at 65° C.

The most commonly used coating formulation in today's industrial practice is a water-based organic composite coating that contains water, resins (acrylic. emulsion, polyurethane emulsion, co-polymer emulsion, etc.), isopropyl alcohol (co-solvent), and a large quantity of hexavalent chromates (corrosion inhibitors). This coating formulation works extremely well, but the hexavalent chromates are toxic and carcinogenic that cause lung cancer, and kidney and liver damage, and isopropyl alcohol is considered as hazardous air pollutants (HAPs). When OSHA implements the projected stringent limits within the next few years, many chromate prier end-users will find it difficult to comply with worker exposure limits and environmental safety.

The competition and challenge started several years ago for developing the chrome-free and HAPs-free water-based anti-fingerprint coatings on galvanized steel for using on high-speed lines. There is no satisfactory formulation known currently that passes the required properties and that are chrome-free and HAPs-free. This invention is described for the first time, chrome-free and HAPs-free water-based anti-fingerprint coatings that pass all required tests. The coating formulations contain 60-70% by weight of water, 15-25% by weight of resins (sub-micrometer or nanometer size resin particles, e.g. acrylic emulsion, polyurethane emulsion, co-polymer emulsion, etc.), 10-20% by weight of HAPs-free co-solvents, 0.5-5% of organofunctional silanes sterically hindered substituents at silicon atoms (the functional groups are vinyl, epoxy, sulfur, amino, etc.), 0.1-1.0% corrosion inhibitors (silicates, vanadates, manganates, phosphates, organic carboxylates, etc.) and a trace amount of pH adjusting agents (ammonia, organic amines, etc.).

### Example 2

Magnesium-based alloys are of interest for many industrial applications due to their favorable strength to weight ratio, such as AZ91 and ZE41. However, it is the corrosion resistance that often limits the applications of magnesium-based alloys. Furthermore, the surface of a magnesium alloy is known to be very difficult to coat. Even with the chromic acid (toxic and carcinogenic) treatment applied it causes serious problems such as insufficient adhesive strength resulting from a release agent and unevenness of treatment involved and inadequate corrosion resistance incurred from slight impurities contained in the materials.

The current surface treatment processed for magnesium alloys are chromate conversion coating non-chromate (i.e. manganate, vanadate, stannate, etc.) conversion coating, cold phosphate conversion coating, and galvanic anodizing treatment. The processes involve multiple steps and are error-prone and costly. The multi-step surface treatment technologies produce waste including organic solvents, heavy metals, and other toxic and deleterious materials.

Applicants have used a green chemistry approach and developed an aqueous emulsion coating for surface treatment of magnesium alloys. The emulsion contains only environmentally safe chemicals, and precursors hybridized of acrylic co-polymers and silanes.

A single-coat application of “Acryl-Mg-Sol” on magnesium alloy surface, followed by a thermal curing at 150 degrees C. for 5 minutes has shown to give a dry film thickness of approximately 1.6 μm with a resistance of ˜0.3 mΩ/cm. The protective film displays an excellent metal surface adhesion (5B, ASTM D3359), and has passed a salt (fog) spray test (ASTM B117) of >24 hours that is superior to a multi-step chrome (or dichromate) pickle treatment.

### Example 3

The AFP (anti-fingerprint coating) was developed recently in applicant's lab. It has been shown to provide excellent metal surface pretreatment on bare cold-rolled steel (CRS), galvanized steel, magnesium alloys, and titanium alloys. Here, the AFP system is extended and applied to the untreated 2024-T3 Bare Al coupon, by dipping and spinning off the excess emulsion. The pretreated Al coupon is then thermally cured at 150° C. (oven temperature) for 1 min. to give a treated 2024-T3 Bare/AFP Al panel. A 0.8-0.9 mil dry film of AD9318/AD2298 chromate primer was prepared on 2024-T3 Bare/AFP and 2024-T3 Bare/Alodine 1200 coupons, and cured overnight at 49° C. The resistance to corrosion of AFP and Alodine 1200 surface pretreatment on 2024-T3 Bare aluminum alloy is examined by salt spray tests and electrochemical impedance spectroscopy (EIS) scans.

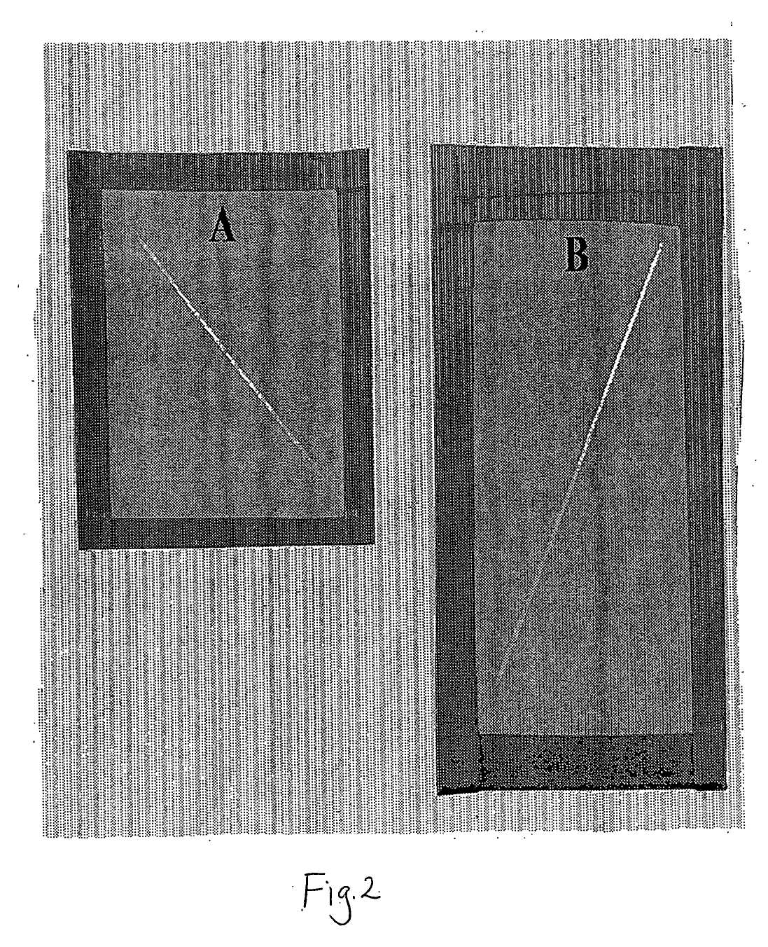

FIG. 2 displays panels of 2024-T3 Bare/Alodine 1200 (photograph A) and on 2024-T3 Bare/AFP (photograph B) coated with AD9318/AD2298 primer after a 1000 hour salt spray test. Both panels are free of white rust, field blisters, white pits, or other undesirable defects. The photograph shown in FIG. 2A (Alodine 1200 panel) shows stains along the X-scribe area.

The photograph shown in FIG. 2B (AFP panel) is free of stain. A slight discoloration (i.e., a leaching of chromate anti-corrosive pigments) is observed in FIG. 2A, but not in FIG. 2B. This is an important observation, because the non-chromate AFP surface pretreatment retains the chromate anti-corrosive pigments in the primer, while the Alodine 1200 pretreatment does not. The ability of AFP to retain the chromate pigments in the primer film will prolong the effect of corrosion resistance and, more importantly, reduces the possibility of chromate contaminations of the groundwater and environment.

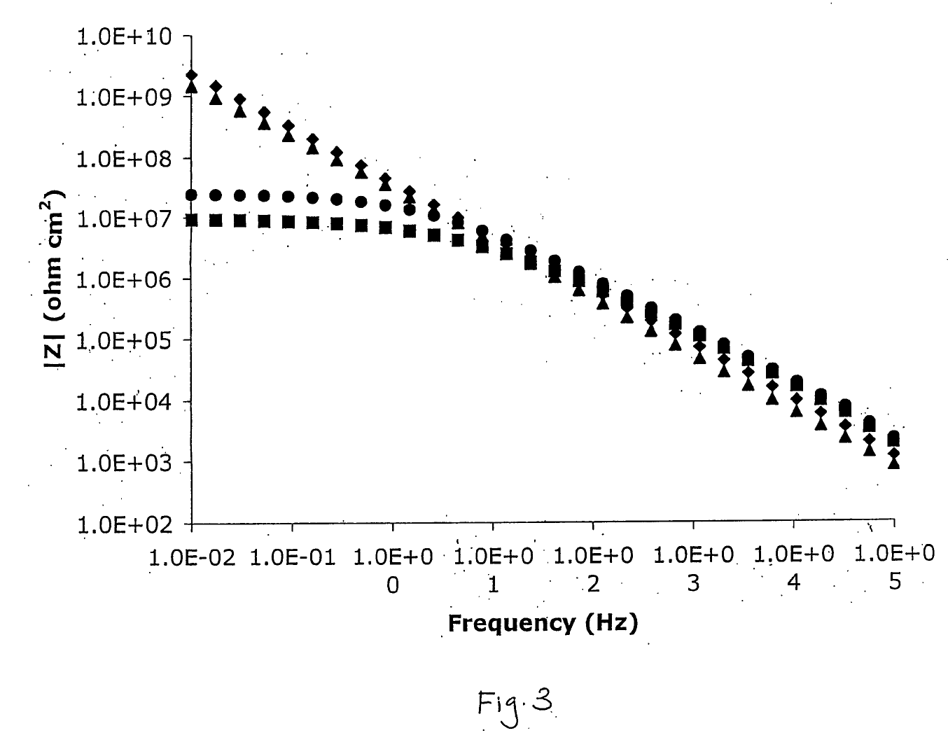

The salt spray testing results are in good agreement with the EIS measurements. FIG. 3 shows the Bode-magnitude plots (frequency vs. impedance) of AD9318/AD2298 coated on 2024-T3 Bare/AFP panels after soaking in 3% NaCl solution for 72 hours (♦) and 1000 hours (▴), and those on 2024-T3 Bare/Alodine 1200 panels soaked for 72 hours (●) and 1000 hours (▪). The paint film of AD9318/AD2298 coated on 2024-T3 Bare/AFP panel has a slope of nearly −1, indicating to a pure capacitor, with a high impedance value of 4×10⁹ Ω·cm² at 0.01 Hz (♦). This high quality of paint film protective performance is completely retained after soaking in 3% NaCl solution for 1000 h (▴). On the other hand, the paint film of AD9318/AD2298 coated on 2024-T3 Bare/Alodine 1200 panel shows some stains in the salt spray test (FIG. 2A) and thus gives a low impedance value of 4×10⁷ Ω·cm² (●) that is 100 times lower than the painted AFP panel. A reduction in impedance value is also observed for the painted Alodine 1200 panel after soaking in 3% NaCl solution for 1000 hours (▪).

Throughout this application, author and year and patents by number reference various publications, including United States patents. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology that has been used is intended to be in the nature of words of description rather than of limitation.

Obviously, many modifications and variations of the present invention are possible in light of the above teachings. It is, therefore, to be understood that within the scope of the described invention, the invention may be practiced otherwise than as specifically described.

1. A coating composition comprising a chrome-free environmentally friendly formulation.

2. The coating according to claim 1, wherein said composition includes water, resins, hazardous air pollutants-free co-solvents, organofunctional silanes, metal chelating agents, and chrome-free corrosion inhibitors.

3. The coating according to claim 2, wherein said composition further includes at least one pH adjusting agent.

4. The coating according to claim 2, wherein said water is present in a range of 60-70% by weight, and preferably present in a range of 61-63% by weight.

5. The coating according to claim 2, wherein said resin is present in a range of 15-25% by weight and preferably in a range of 20-23% by weight is preferred.

6. The coating according to claim 2, wherein said resin is of a size selected from the group consisting essentially of micro- and nano-particle size.

7. The coating according to claim 5, wherein said resin is selected from the group consisting essentially of an acrylic emulsion, a polyurethane emulsion, a co-polymer emulsion, and other similar compounds.

8. The coating according to claim 2, wherein said hazardous air pollutants (HAPs)-free co-solvents are present in a range of 10-20% by weight and preferably in a range of 15-17% by weight.

9. The coating according to claim 11, wherein said hazardous air pollutants (HAPs)-free co-solvents are selected from the group consisting essentially of DPnB and PnB co-solvents.

10. The coating according to claim 2, wherein said organofunctional silanes are present in a range of 0.4-5% by weight and preferably in a range of 1.5-2.5% by weight is preferred.

11. The coating according to claim 10, wherein said organofunctional silanes include sterically hindered substituents located at silicon atoms.

12. The coating according to claim 11, wherein said substituents are selected from the group consisting essentially of vinyl, epoxy, sulfur, amino, functionalized mercaptosilanes, and aminosilanes.

13. The coating according to claim 2, wherein said corrosion inhibitors are present in a range of 0.1-1.0% by weight and preferably in a range of 0.3-0.5% by weight is preferred.

14. The coating according to claim 11, wherein corrosion inhibitor is selected from the group consisting essentially of silicates, vanadates, metaborates, manganates, phosphates, mercapto-compounds, xanthic acid salts, dithiocarbamic acid salts, organic carboxylates, and other similar compounds.

15. The coating according to claim 3, wherein said composition includes trace amounts of pH adjusting agents.

16. The coating according to claim 15, wherein pH adjusting agent is selected from the group consisting essentially of ammonia, organic amines, and other similar agents.

17. A metal alloy coated with the coating composition as set forth in claim 1.

18. An anti-corrosion coating comprising the composition set forth in claim 1.

19. An anti-fingerprint coating comprising the composition set forth in claim 1.

20. A highly adhesive coating to the metal alloys and galvanized steel as set forth in claim 1.

21. A highly adhesive coating to the subsequent liquid and powder paints as set forth in claim 1

22. The galvanized and galvalume coats with the coating composition as set forth in claim 1.
